(19) United States
(12) Patent Application Publication
(10) Pub. No.: US 2013/0133629 A1
(43) Pub. Date: May 30, 2013

(54) CONTROL OF THE TEMPERATURE OF ADSORBENT MATERIALS IN A CANISTER

(71) Applicant: AISAN KOGYO KABUSHIKI KAISHA, Obu-shi (JP)

(72) Inventor: Tamotsu OGITA, Obu-shi (JP)

(73) Assignee: AISAN KOGYO KABUSHIKI KAISHA, Obu-shi (JP)

(21) Appl. No.: 13/670,608

(22) Filed: Nov. 7, 2012

(30) Foreign Application Priority Data
Nov. 24, 2011 (JP) 2011-255854

(51) Int. Cl. F02M 25/08

(52) U.S. Cl. CPC F02M 25/08
USPC 123/519

(57) ABSTRACT

A method for cooling an adsorbent material filled in a housing of an adsorbent-canister in a vehicle. The vehicle preferably has a cooler and a fuel door. The method may include the steps of detecting an opened or closed state of the fuel door, and when the fuel door is open, starting the cooler in order to cool the adsorbent material.

### CROSS-REFERENCES TO RELATED APPLICATIONS

This application claims priority to Japanese Patent Application Serial Number 2011-255854, the contents of which are incorporated herein by reference.

### BACKGROUND OF THE INVENTION

1. Field of the Invention

The present application relates to emissions control in vehicles, and more particular, to temperature control of adsorbent materials in emissions control apparatuses.

2. Description of the Related Art

Japanese Laid-Open Patent Publication No. 2008-38708 teaches an emissions control apparatus having an adsorbent-canister filled with an adsorbent material, a heater for heating the adsorbent material, a cooler for cooling the adsorbent material, and a regulator for controlling the heater and the cooler. The adsorbent-canister can temporarily trap fuel vapor which is vaporized in a fuel tank of a vehicle. The adsorbent canister can also release fuel vapor during purge operations in order to send the trapped fuel vapor to an internal combustion engine. The regulator drives the heater and the cooler in accordance with the remaining amount of fuel in the fuel tank. The regulator is used in order to control temperature of the adsorbent material. That is, when the adsorbent material is adsorbing fuel vapor, the regulator drives the cooler in order to improve the adsorbing capacity of the adsorbent-canister. Conversely, when the adsorbent material is desorbing fuel vapor, the regulator drives the heater in order to promote the release of fuel vapor.

Conventional emissions control apparatuses drive the cooler and thus cool the adsorbent material in accordance with the remaining amount of fuel in the fuel tank, i e., the amount of fuel vapor flowing into the adsorbent-canister. So, in a state where the remaining amount of fuel is over a predetermined amount, the adsorbent material is not cooled because the cooler does not operate. Accordingly, in such a state, the cooler does not cool the adsorbent material during the refueling of the vehicle. In another situation, the heater operates before refueling. This occurs because the temperature of the adsorbent material is high and the adsorbing capacity of the adsorbent-canister is low during refueling. Accordingly, there has been a need for improved methods in cooling the adsorbent material.

### SUMMARY OF THE INVENTION

One aspect of the present invention discloses a method for cooling an adsorbent material filled in a housing of an adsorbent-canister in a vehicle. The vehicle may have a cooler and a fuel door. The method may include the steps of detecting an opened or closed state of the fuel door, and when the opened state of the fuel door is detected, starting the cooler in order to cool the adsorbent material.

In accordance with this aspect of the invention, it is able to cool the adsorbent material before refueling regardless of the remaining amount of fuel in the fuel tank nor the temperature of the adsorbent material.

In another aspect of the present disclosure, a method for cooling an adsorbent material in a housing of an adsorbent-canister in a vehicle is disclosed. The vehicle may have a cooler and a fuel door. The method may include the steps of detecting an opened or closed state of the fuel door, measuring the temperature of the adsorbent material, and when the opened state of the fuel door is detected and the measured temperature of the adsorbent material is equal to or higher than a predetermined temperature, starting the cooler in order to cool the adsorbent material.

In accordance with this aspect, it is able to cool the adsorbent material before refueling regardless of the remaining amount of fuel in the fuel tank. In addition, when the temperature of the adsorbent material is equal to or higher than the predetermined temperature, the adsorbent material is cooled. That is, when the temperature of the adsorbent material is lower than the predetermined temperature, the cooler does not operate, so it is able to cool the adsorbent material before refueling in order to save energy used in powering the cooler.

### BRIEF DESCRIPTION OF THE DRAWINGS

In the accompanying drawings:

FIG. 1 is a schematic diagram of an emissions control system in a first embodiment;

FIG. 2 illustrates a method for driving a cooling fan by an ECU in the first embodiment;

FIG. 3 illustrates a method for driving a cooling fan by an ECU in a second embodiment;

FIG. 4 shows a graph showing the desired revolutions of a cooling fan in accordance with the temperature of adsorbent material in the second embodiment; and

FIG. 5 is a schematic diagram of an emissions control system in a third embodiment.

### DETAILED DESCRIPTION OF THE INVENTION

Each of the additional features and teachings disclosed above and below may be utilized separately or in conjunction with other features and teachings to provide improved methods for cooling adsorbent material. Representative examples of the present invention, which examples utilize many of these additional features and teachings both separately and in conjunction with one another, will now be described in detail with reference to the attached drawings. This detailed description is merely intended to teach a person of ordinary skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

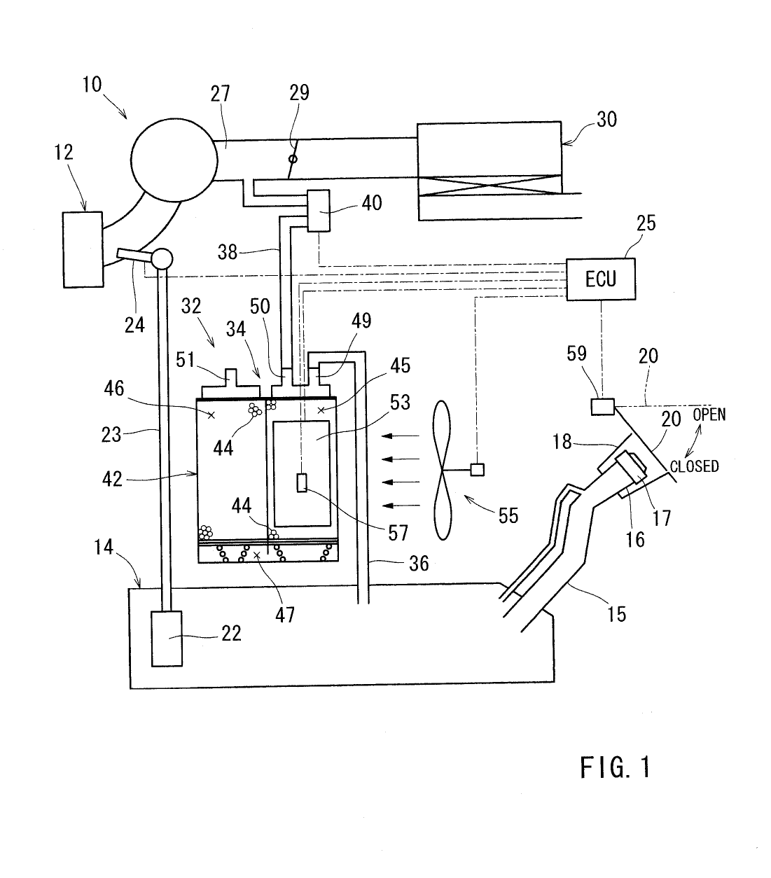

A first embodiment of this disclosure will be described. This embodiment is an emissions control apparatus mounted on a vehicle such as automobile having an internal combustion engine (referred to as engine, hereafter). For convenience of explanation, an emissions control system will first be described, and then an emissions control apparatus will be described afterwards. FIG. 1 shows a schematic diagram of an emissions control system of the first embodiment.

As shown in FIG. 1, an emissions control system 10 of a vehicle (not shown) includes an engine 12 and a fuel tank 14. The engine 12 is, for example, a gasoline engine. The fuel tank 14 is provided with an inlet pipe 15 for supplying fuel into the fuel tank 14. The inlet pipe 15 has a fill opening 16 at an upper end thereof, and the fill opening 16 has a cap 17 that is removable. The fill opening 16 is positioned in a fuel inlet box 18 formed in the vehicle (in detail, vehicle body). The fuel inlet box 18 is provided with a fuel door 20 for covering an opening of the fuel inlet box 18 such that the fuel door 20 can pivot by a hinge, i.e., it can open and close the opening of the fuel inlet box 18. In order to refuel via the fill opening 16, it is necessary to open the fuel door 20 (refer to the two-dot chain line 20 in FIG. 1) and remove the cap 17.

The fuel tank 14 is provided with a fuel pump 22 therein. The fuel pump 22 pumps fuel, which is held in the fuel tank 14, through a fuel supply conduit 23 to a fuel injection valve, i.e., injector 24. Then, the injector 24 supplies fuel into an intake port of the engine 12. The injector 24 is controlled by an engine control unit (refer to ECU, hereafter) 25. The intake port is fluidly coupled to an intake conduit 27. The intake conduit 27 has a throttle valve 29 used to open and close the intake conduit 27, and an air cleaner 30 upstream of the throttle valve 29, i.e., nearer an air intake opening.

The emissions control system 10 includes an emissions control apparatus 32 that, among other things, has an adsorbent-canister 34, a vapor conduit 36, a purge conduit 38 and a purge valve 40. The adsorbent canister 34 has a housing 42 filled with an adsorbent material 44 that can removably trap fuel vapor. Accordingly, when fuel vapor flows into the housing 42, the adsorbent material 44 temporarily traps fuel vapor, and then when air flows into the housing 42 during a purge operation, fuel vapor is desorbed from the adsorbent material 44 and flows toward the engine 12 together with the air.

The vapor conduit 36 fluidly connects the housing 42 of the adsorbent-canister 34 to an upper portion of the fuel tank 14, where gaseous fuel exists. The purge conduit 38 fluidly couples the housing 42 of the adsorbent-canister 34 to the intake conduit 27 (in particular, downstream of the throttle valve 29). The purge valve 40 consists of a solenoid valve and is positioned at the middle of the purge conduit 38. The ECU 25 controls the purge valve 40 in order to switch the opening and closing states of the purge conduit 38.

Next, the structure of the adsorbent-canister 34 will be described. For convenience of explanation, upper, lower, right and left directions are defined as shown in the diagram of FIG. 1. As shown in FIG. 1, the housing 42 of the adsorbent-canister 34 has a first adsorption chamber 45 on a right side, a second adsorption chamber 46 on a left side and a communication chamber 47 for allowing fluid communication between the lower portions of the first adsorption chamber 45 and the second adsorption chamber 46. That is, the first adsorption chamber 45, the communication chamber 47 and the second adsorption chamber 46 together form a U-shaped gas passage. The first adsorption chamber 45 and the second adsorption chamber 46 are filled with adsorbent material 44. As described above, the adsorbent material 44 can removably trap fuel vapor. The adsorbent material 44 can be made of crushed activated carbon (i.e., granular activated carbon), extruded activated carbon (i.e., extruded mixture of powdered activated carbon and a binder) or the like. The adsorbent material 44 may be made of any granular materials capable of removably trapping fuel vapor.

The housing 42 has a tank port 49, a purge port 50 and an atmosphere communicating port 51 at a top end thereof. The tank port 49 and the purge port 50 fluidly communicate with the first adsorption chamber 45, while the atmosphere communicating port 51 fluidly communicates with the second adsorption chamber 46. The tank port 49 is connected to a downstream end of the vapor conduit 36. The purge port 38 is connected to an upstream end of the purge conduit 38. The atmosphere communicating port 51 is open to the atmosphere. Here, the housing 42 is fixed on the vehicle body.

At the center of the first adsorption chamber 45, an electric heater 53 is configured to heat the adsorbent material 44. The heater 53 is preferably located within the adsorbent material 44 in the first adsorption chamber 45. In addition, an electric cooling fan 55 is positioned outside of the housing 42, such that the cooling fan 55 blows towards an outer surface of the first adsorption chamber 45. Here, the ECU 25 controls the heater 53 and the cooling fan 55. The cooling fan 55 is fixed on the vehicle body.

In the first adsorption chamber 45, a temperature sensor 57 for measuring the temperature of the adsorbent material 44 is positioned. A lid open-close sensor 59 is placed in the fuel inlet box 18 for sensing an opened or closed state of the fuel door 20. The temperature sensor 57 and the lid open-close sensor 59 send signals to the ECU 25. The ECU 25 calculates the temperature of the adsorbent material 44 based on the signals from the temperature sensor 57. The ECU 25 detects an opened or closed state of the fuel door 20 depending on the signals from the lid open-close sensor 59.

Next, operation of the emissions control apparatus will be described.

(1) The engine 12 is operating.
In the state where the engine 12 is running, when the ECU 25 opens the purge valve 40, negative pressure in the engine 12 acts on the inside of the housing 42 of the adsorbent-canister 34 via the purge conduit 38. Accordingly, fresh air in the atmosphere flows into the second adsorption chamber 46 via the atmosphere communicating port 51. The air introduced into the second adsorption chamber 46 makes fuel vapor desorb from the adsorbent material 44 filled in the second adsorption chamber 46. Then, the air flows into the first adsorption chamber 45 and makes fuel vapor desorb from the adsorbent material 44 filled in the first adsorption chamber 45. Mixture of the air and fuel vapor that has desorbed from the adsorbent material 44 flows into the engine 12 via the purge conduit 38. For example, when this purge operation finishes or when the engine 12 is stopped, the ECU 25 closes the purge valve 40.

During a purge operation, the ECU 25 detects whether the temperature of the adsorbent material 44 in the first adsorption chamber 45 is equal to or lower than a “removable temperature” (which is a temperature capable of obtaining the desired desorption ability of the adsorbent material 44) depending on the signals from the temperature sensor 57. When the temperature of the adsorbent material 44 is equal to or lower than the removable temperature, the ECU 25 drives the heater 53. Contrastingly, when the temperature of the adsorbent material 44 is higher than the removable temperature, the ECU 25 does not operate the heater 53. When the temperature of the adsorbent material 44 becomes higher due to operation of the heater 53, the adsorbent material 44 can more easily release fuel vapor. For example, when the temperature of the adsorbent material 44 becomes higher than the removable temperature, the ECU 25 stops the heater. Alternatively, when the purge valve 40 is closed, the ECU 25 also stops the heater 53.

(2) The engine 12 is in a resting state.
While the engine 12 is stopped, i.e., parking, gas containing fuel vapor that has vaporized in the fuel tank 14 flows into the first adsorption chamber 45 of the adsorbent-canister 34 via the vapor conduit 36. Then, the adsorbent material 44 in the first adsorption chamber 45 traps the fuel vapor. Remaining fuel vapor, which is not trapped on the adsorbent material 44 in the first adsorption chamber 45, flows into the second adsorption chamber 46 via the communication chamber 47 and becomes trapped on the adsorbent material 44 filled in the second adsorption chamber 46. Then, the gas containing little fuel vapor flows into the atmosphere via the atmosphere communicating port 51.
(3) The vehicle is being refueled.
In order to refuel the vehicle, the user moves the vehicle to a gas station and stops the engine 12. Then, the user opens the fuel door 20 and removes the cap 17 prior to refuel, and then supplies liquid fuel via the fill opening 16. After refueling, the user attaches the cap 17 to the filling opening 16 and closes the fuel door 20.

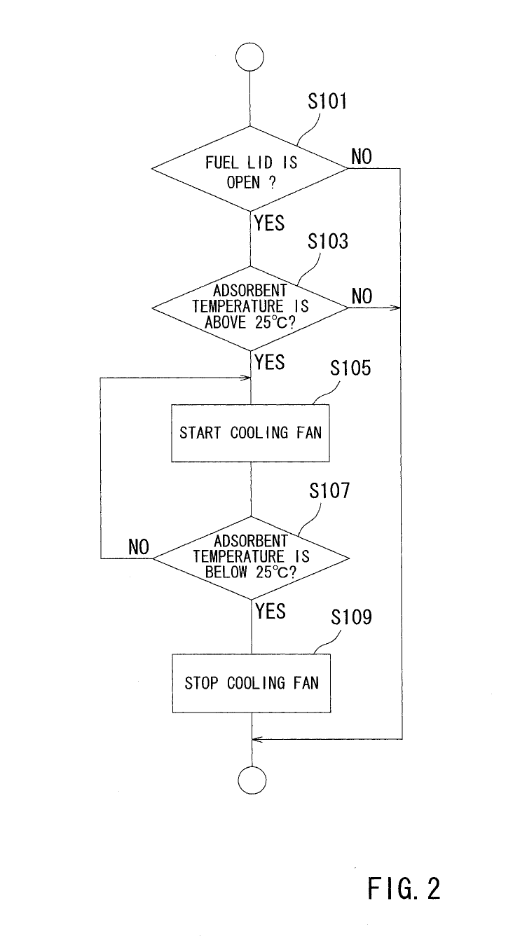

Next, one example of drive control of the cooling fan 55 during refuel will be described. When the fuel door 20 is opened prior to refueling, the lid open-close sensor 59 sends signals to the ECU 25. When the ECU 25 detects the opening state of the fuel door 20 in accordance with the signals from the lid open-close sensor 59, the ECU 25 starts the cooling fan 55. FIG. 2 illustrates a flowchart showing drive control of the cooling fan 55 by the ECU 25.

As shown in FIG. 2, in Step S101, the ECU 25 detects whether the fuel door 20 is open or not. In the state that the fuel door 20 is open, the user starts to refuel from this time. In addition, in the case that the fuel door 20 is open, in Step S103, the ECU 25 detects whether the temperature of the adsorbent material 44 is equal to or higher than the “adsorbable temperature” (25° C. in this embodiment) or not depending on the signals from the temperature sensor 57. The term “adsorbable temperature” means a temperature capable of obtaining the desired adsorption ability. When the temperature of the adsorbent material 44 is equal to or higher than 25° C. in Step S103, the ECU 25 starts the cooling fan 55 in Step S105. When the cooling fan 55 is operated, the cooling fan 55 blows toward the housing 42 of the adsorbent-canister 34. Due to this action, the adsorbent material 44 in the adsorbent-canister 34 is cooled, so that the adsorption ability of the adsorbent material 44 becomes higher.

Then, in Step S107, the ECU 25 detects whether the temperature of the adsorbent material 44 drops below 25° C. or not depending on the signals from the temperature sensor 57. When the second measured temperature of the adsorbent material 44 is equal to or higher than 25° C., Steps S105 and S107 are repeated at regular time intervals. Whereas, when the temperature of the adsorbent material 44 is below 25° C. in Step 107, the ECU 25 stops the cooling fan 55 in Step S109, so this drive control finishes. In addition, when the ECU 25 detects that the fuel door 20 in Step S101 is closed, this control finishes without operating the cooling fan 55. Further, in the case that the temperature of the adsorbent material 44 is below 25° C. in Step S103, since it is not necessary to cool the adsorbent material 44, this drive control also finishes without operating the cooling fan 55.

In the emissions control apparatus 32, when the ECU 25 detects the open state of the fuel door 20 based on the signals from the lid open-close sensor 59, the ECU 25 drives the cooling fan 55. Thus, despite the remaining amount of fuel in the fuel tank 14, the ECU 25 drives the cooling fan 55 prior to start of refueling. In this situation, the adsorbent material 44 is cooled in order to improve the adsorption ability of the adsorbent material 44 before the start of refueling. This configuration provides useful improvement of the adsorption ability of the adsorbent material 44 for refueling when the temperature of the adsorbent material 44 is high due to action of the heater 53.

When the fuel door 20 is open and the temperature of the adsorbent material 44 is equal to or higher than the predetermined temperature (e.g., 25° C.), the ECU 25 drives the cooling fan 55 in order to cool the adsorbent material 44. However, when the temperature of the adsorbent material 44 is below the predetermined temperature, the ECU 25 does not drive the cooling fan 55. Accordingly, it is able to save energy for powering the cooling fan 55.

In addition, when the temperature of the adsorbent material 44 drops below the predetermined temperature during driving the cooling fan 55, the ECU 25 stops the cooling fan 55. Thus, it is able to save energy for powering the cooling fan 55.

The cooling fan 55 is positioned to blow toward the housing 42 of the adsorbent-canister 34 in order to cool the adsorbent material 44.

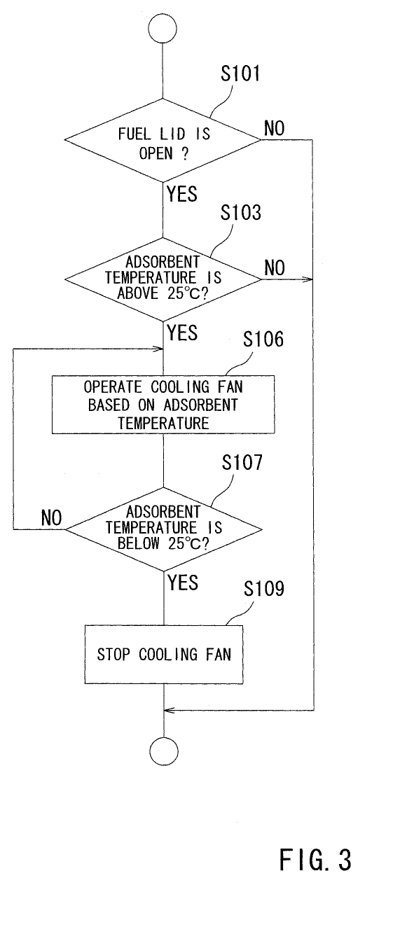

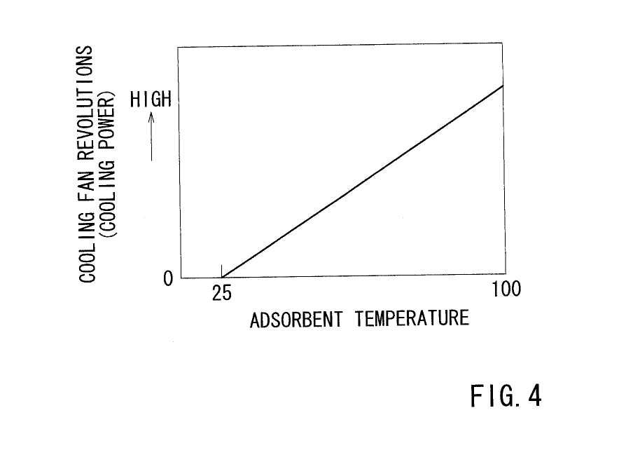

A second embodiment will be described. Since this embodiment substantially corresponds to the first embodiment with some changes, such changes will be described while the same constructions will not be described. FIG. 3 illustrates a flowchart showing a method for controlling the cooling fan by the ECU. FIG. 4 is a graph showing the required revolutions of the cooling fan in accordance with the temperature of the adsorbent material.

In this embodiment, the ECU 25 stores the graph showing the required revolutions of the cooling fan 55 based on the temperature of the adsorbent material 44 (refer to FIG. 4). This graph is determined based on preliminary experiments, etc. Here, the revolutions of the cooling fan 55 correspond to “cooling power” in this disclosure.

As shown in FIG. 3, the ECU 25 carries out Step S106 instead of Step S105 of the first embodiment (that is shown in FIG. 2). In Step S106, the ECU 25 calculates the required revolutions of the cooling fan 55 based on the temperature of the adsorbent material 44. The temperature is measured based on the signals from the temperature sensor 57. Then, depending on the temperature of the adsorbent material 44 (FIG. 4), the ECU 25 regulates the revolutions of the cooling fan 55 based on the calculated result. The number of revolutions is determined in accordance with the graph for the revolutions of the cooling fan 55. Accordingly, the higher the temperature of the adsorbent material 44 is, the higher the cooling power of the cooling fan 55 becomes in order to reduce the time required to cool the adsorbent material 44. In addition, the lower the temperature of the adsorbent material 44 is (under a condition that the temperature is higher than the predetermined temperature), the lower the cooling power of the cooling fan 55 becomes in order to save the energy for powering the cooling fan 55.

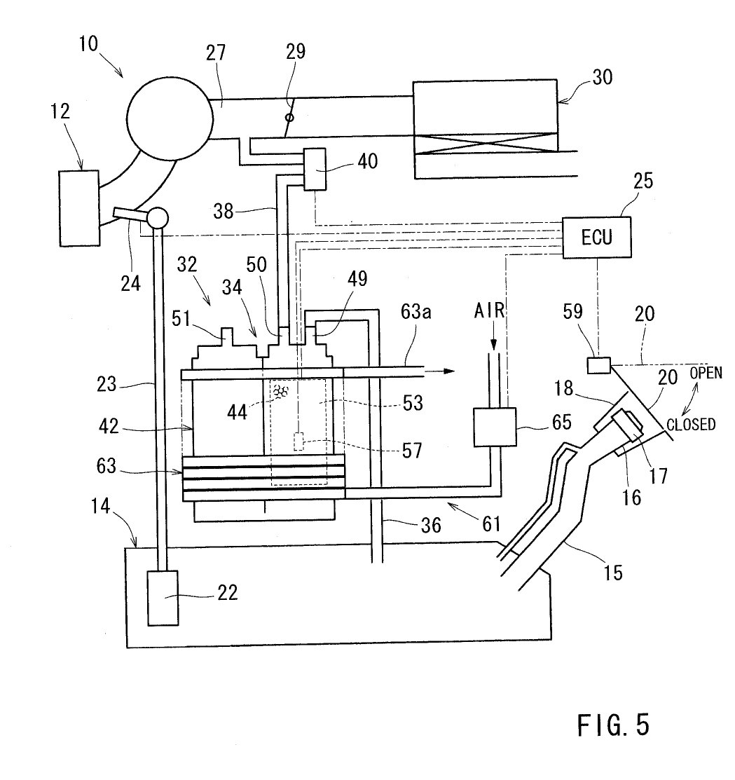

Next, a third embodiment will be described. This embodiment substantially corresponds to the first embodiment with some changes. So, such changes will be described, whereas the other same constructions will not be described. FIG. 5 is the schematic diagram showing the emissions control system of the third embodiment.

As shown in FIG. 5, the emissions control apparatus 32 of this embodiment has a cooling device 61 instead of the cooling fan 55 of the first embodiment (that is shown in FIG. 1). The cooling device 61 has a cooling pipe 63 positioned around the housing 42 of the adsorbent-canister 34 and an air pump 65 for forcing cooling air through the cooling pipe 63. The cooling pipe 63 is placed around the housing 42 in a helical shape. The air pump 65 is controlled by the ECU 25. When the ECU 25 starts the air pump 65, fresh air (in the atmosphere) is suctioned into the air pump 65, and sent through the cooling pipe 63. It is then released into the atmosphere from an end 63a of the cooling pipe 63. Due to this operation, the adsorbent material 44 is cooled. Here, the air pump 65 corresponds to a “cooling pump” in this disclosure. Furthermore, it is able to use a water pump for using water or the like as a liquid cooling medium instead of the air pump 65. In such a case, the cooling pipe 63 is shaped as a circular loop through the water pump.

Other envisioned modifications will be described. Obviously, modifications are not limited to the following, and any other modification can be combined with this disclosure. For, example, the adsorbent-canister 34 may have one adsorption chamber or three or more adsorption chambers. The adsorbent-canister 34 may have a plurality of heaters in each adsorption chamber. The heater 53 may be positioned outside of the housing 42 of the adsorbent-canister 34. The emissions control apparatus 32 may have a plurality of cooling fans 55 or cooling devices 61. Step S103 may be carried out before step S101.

1. A method for cooling an adsorbent material filled in a housing of an adsorbent-canister in a vehicle, the vehicle having a cooler and a fuel door, the method comprising the steps of:
detecting an opened or closed state of the fuel door; and
when the opened state of the fuel door is detected, starting the cooler in order to cool the adsorbent material.

2. The method according to claim 1, further comprising a step of:
measuring a first temperature of the adsorbent material before the starting the cooler step such that when the first temperature of the adsorbent material is equal to or higher than a predetermined temperature, the starting the cooler step is carried out.

3. The method according to claim 2, further comprising a step of:
regulating a cooling power of the cooler depending on the first temperature of the adsorbent material after the starting the cooler step.

4. The method according to claim 2, further comprising a step of:
measuring a second temperature of the adsorbent material after the starting the cooler step; and
when the second temperature is lower than the predetermined temperature, stopping the cooler.

5. The method according to claim 2, where the adsorbent material is made of activated carbon and the predetermined temperature is 25° C.

6. The method according to claim 1, where the cooler is a cooling fan.

7. The method according to claim 1, where the cooler comprises a cooling pipe positioned around the housing of the adsorbent-canister and a cooling pump configured to flow cooling medium through the cooling pipe.

8. The method according to claim 4, where when the second temperature is equal to or higher than the predetermined temperature, the second measuring step is repeated again after a certain period of time from the second measuring step.

9. A method for cooling an adsorbent material filled in a housing of an adsorbent-canister in a vehicle, the vehicle having a cooler and a fuel door, the method comprising the steps of:
detecting an opened or closed state of the fuel door;
measuring a first temperature of the adsorbent material; and
when the opened state of the fuel door is detected and the first temperature of the adsorbent material is equal to or higher than a predetermined temperature, starting the cooler in order to cool the adsorbent material.

10. The method according to claim 9, further comprising a step of:
regulating a cooling power of the cooler depending on the first temperature of the adsorbent material.

11. The method according to claim 10, further comprising a step of:
measuring a second temperature of the adsorbent material after the regulating step; and
stopping the cooler when the second temperature is lower than the predetermined temperature.

12. The method according to claim 10, further comprising a step of:
measuring a second temperature of the adsorbent material after the regulating step; and
when the second temperature is equal to or higher than the predetermined temperature, regulating cooling power of the cooler depending on the second temperature of the adsorbent material.

13. The method according to claim 10, where the higher the first temperature of the adsorbent material is, the higher the cooling power is regulated.
